(19) United States
(12) Patent Application Publication
(10) Pub. No.: US 2007/0201313 A1
(43) Pub. Date: Aug. 30, 2007

(54) Radio-Controlled Wristwatch With Means For Decoding Signals From Time Signal Transmitters From A Number Of Time Zones

(76) Inventors: Holger Rudolph, Bibertal-Buhl (DE); Gunter Megner, Uhldingen (DE); Rudiger Daut, Lautersbach (DE)

Correspondence Address: NATH & ASSOCIATES, 112 South West Street, Alexandria, VA, 22314, US

(21) Appl. No.: 11/578,031

(22) PCT Filed: Jan. 18, 2005
(86) PCT No.: PCT/EP05/00447

§ 371 Date: Oct. 12, 2006

(30) Foreign Application Priority Data
Apr. 15, 2004 (DE) 10 2004 018 881.5

(51) Int. Cl. G04C 11/02

(52) U.S. Cl. 368/47

(57) ABSTRACT

The radio-controlled wristwatch comprises a memory unit (30) in which a table of more than four time signal transmitters (1 . . . 10) from more than two time zones (A . . . N) is stored. Attempts for receiving from the transmitters (1 . . . 10) filed in the table are made by a control device (28), and upon a successful reception of a time signal transmitter (1 . . . 10) from the table, the appurtenant time is displayed upon the display (32) of the wristwatch (20).

Radio-controlled wristwatch with means for decoding signals from time signal transmitters from a number of time zones

The present invention relates to a radio-controlled wristwatch with means for decoding signals from time signal transmitters from a number of time zones according to the features of the preamble to Claim 1.

Radio-controlled clocks, in which the clock time is displayed in analog form with conventional hands or digitally with a digital display and the information for the present clock time is obtained from signals received from time signal transmitters, are common knowledge. The signals received from the time signal transmitters are high frequency signals that are broadcast by local government agencies of various countries, in order to provide official local time information that enables private individuals to synchronize their clocks and time-measuring instruments. Examples of existing HF time signals include e.g. the DCF signal in Germany, the MSF signal in the United Kingdom, the WWVB signal in the United States of America, and the JJY40 signal and the JJY60 signal in Japan. These signals are amplitude modulated signals with various carrier frequencies and various data protocols.

The following table shows the currently best-known time signal transmitters by country, with their high frequency signal codes and their carrier frequencies:

| | High frequency | |
|---|---|---|
| Countries | signal code | Carrier frequency |
| Central Europe including | DCF | 77.5 kHz |
| France, Germany and Italy | | |
| United Kingdom | MSF | 60 kHz |
| United States of America and Canada | WWVB | 60 kHz |
| Japan (west side) | JJY60 | 60 kHz |
| Japan (center and east side) | JJY40 | 40 kHz |

Most of the known radio-controlled clocks are suitable for receiving only a single time signal transmitter, and hence cannot be used in different countries, i.e. within the realm of various time zones.

However, DE 103 15 429 A1 already describes a radio-controlled clock that is able to receive the time signals of different time signal transmitters in various countries and various time zones and thus can display the current time in different time zones under radio control. To this end, the radio-controlled clock has a relatively voluminous housing in which both the display unit and three different decoders for decoding the different time signals are accommodated. These decoders are controlled by a CPU control unit. A first decoder decodes the DCF and MSF signals in order to decode the DCF radio signals at 77.5 kHz and the MSF radio signals at 60 kHz. A second decoder is provided for decoding the WWVB radio signal at 60 kHz, and a third decoder decodes the Japanese JJY radio signals at 60 kHz and 40 kHz. An LCD display serves as the display device. Various antenna modules can be connected to the housing from outside. Depending on which antenna module is connected at the time, the electronics of the radio clock attempt to receive and decode the corresponding time signals.

A problem with this radio clock is that the antenna modules must be exchanged manually. The operator has the choice among three antenna modules for this. The first antenna module is made so that it can receive DCF HF time signals with a carrier frequency of 77.5 kHz. The second antenna module is designed so that it receives MSF, WWVB and JJY60 HF time signals with a carrier frequency of 60 kHz, independent of the selected code type, and the third antenna module is made so that it can receive JJY40 HF time signals with a carrier frequency of 40 kHz.

The manual changing of the antenna modules is less user-friendly. The operator must always be sure that the correct antenna module is connected to the radio clock in the particular reception area of a time signal transmitter. In particular for business people who travel a lot, who frequently change time zones, such manual changing of the antenna modules is a great nuisance and also takes up a lot of room, since all of the antenna modules always have to be taken along in order to ensure reception of the radio signal of the locally active time transmitter in the respective time zones.

DE 198 08 431 A1 of the present applicant describes a radio clock that is suitable for receiving different transmitter frequencies of various time signal transmitters, and which provides to that end a system of frequency switching through suitable switching capacity in the antenna oscillating circuit. Additional details with regard to the radio clock employed and the possibility of which time signal transmitters are to be received cannot be found in that document.

According to the knowledge of the applicant, radio-controlled wristwatches from the Japanese company Citizen are in use. However, the watches developed by that company can only receive the Japanese time signal transmitters JJY40 and JJY60, and thus only time signal transmitters for the Japanese time zone.

In addition, according to the knowledge of the applicant the Japanese company Casio is supposed to have developed radio-controlled wristwatches that can switch between the Japanese and the American time zones, and thus between two time zones, and supposedly can receive the Japanese transmitters JJY40 and JJY60 as well as the US transmitter WWVB. With these watches, the switching of the time signal transmitter to be received between the Japanese and the American time zones must be done manually by the wearer of the watch.

The present invention has the goal of specifying a radio-controlled wristwatch that displays the time throughout the world under radio control, as long as time signal transmitters can be received. At the same time, manual intervention by the wearer of the watch is to be avoided.

This problem is solved by a radio controlled wristwatch having the features of Claim 1.

Refinements of the invention are the subject of the subordinate claims.

The invention is based essentially on the fact that in the radio controlled wristwatch a memory unit is provided in which a table of at least four time signal transmitters from more than two time zones is stored, and that attempts to receive from the transmitters stored in the table are performed automatically by means of a control device. When reception of a time signal transmitter from the table is successful, the corresponding decoded time is displayed in analog or digital form on the display of the wristwatch.

To this end the radio-controlled wristwatch is equipped with a receiving device that can switch via connected quartz crystals between the necessary carrier frequencies of the possible time signal transmitters.

A refinement of the invention provides that the time signal transmitters stored in the table are grouped according to time zones. This has the advantage that with a previously determined time zone in which the radio-controlled wristwatch is located, only the time signal transmitters of that particular time zone are queried for possible successful attempts at reception. This ensures faster time signal reception in comparison to the solution in which all time signal transmitters stored in the table are queried for possible receivable signals.

If all of the time signal transmitters stored in the table or only those that are grouped for a time zone are to be queried, this is expediently done in sequence for the entire table or for the group of time signal transmitters of the applicable time zone.

A refinement of the invention provides that an additional item of information can be stored in the memory device, which shows the time signal transmitter with which a most recent valid reception attempt was carried out. On the basis of this stored information, the control device begins a new reception attempt with the reception of precisely this time signal transmitter. This refinement has the advantage that when a new attempt at reception is made it is not necessary to query all of the time signal transmitters one after the other for possible reception successes, but rather the querying starts with the time signal transmitter with which a successful attempt at reception was last identified. The probability is after all relatively great that the wearer of the watch has not changed time zones the next time an attempt at reception is made. Rapid adjusting and reception of radio signals is ensured with this refinement.

Another refinement of the invention provides that a quartz time base is located within the radio-controlled wristwatch and enables quartz-precision display by the watch. Such a quartz-precision display of the watch is necessary when no radio signals at all can be received from time signal transmitters.

The invention will be described below in greater detail in connection with exemplary embodiments. The figures show the following:

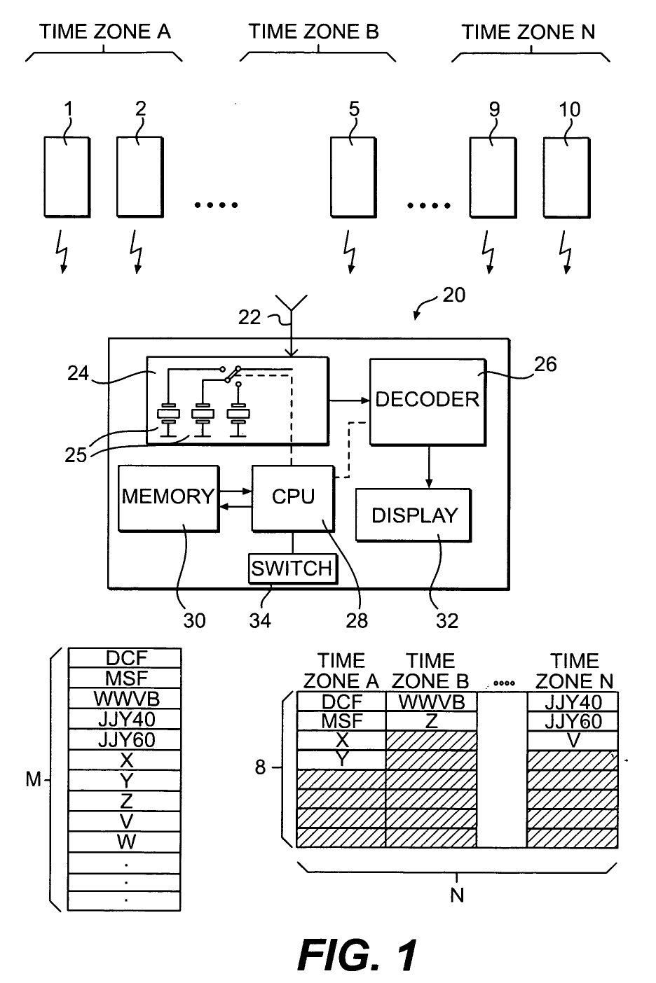

FIG. 1: a schematic diagram of a radio-controlled wristwatch according to the invention,

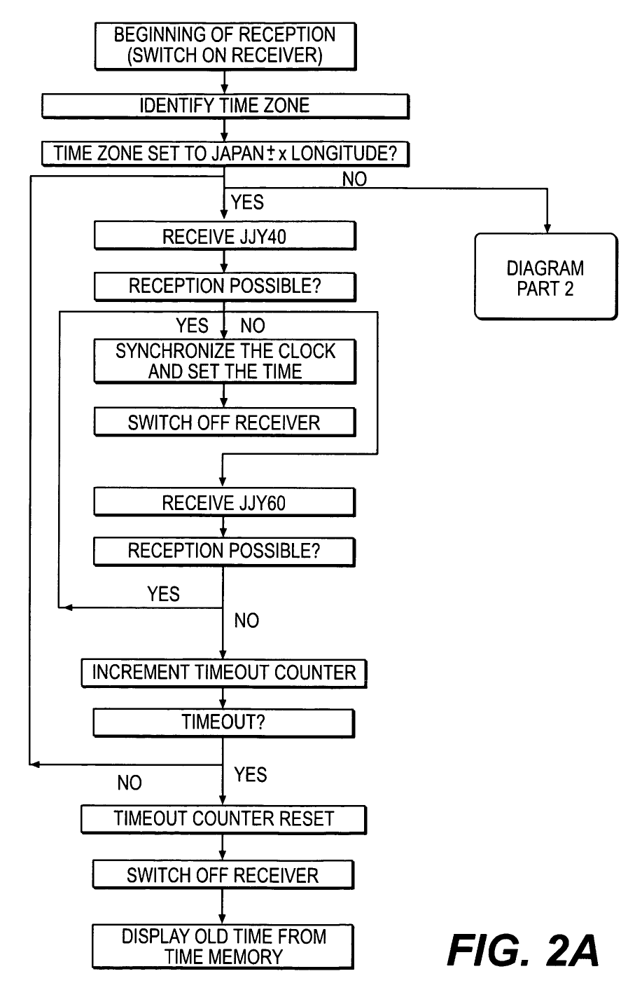

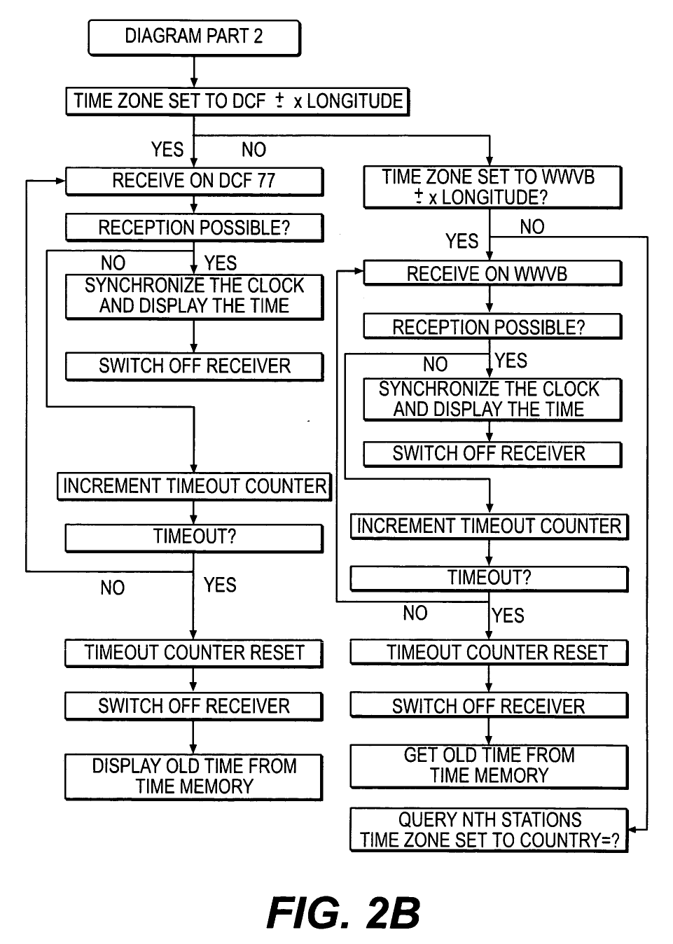

FIG. 2: a flow chart for an exemplary embodiment of a radio-controlled wristwatch according to the invention,

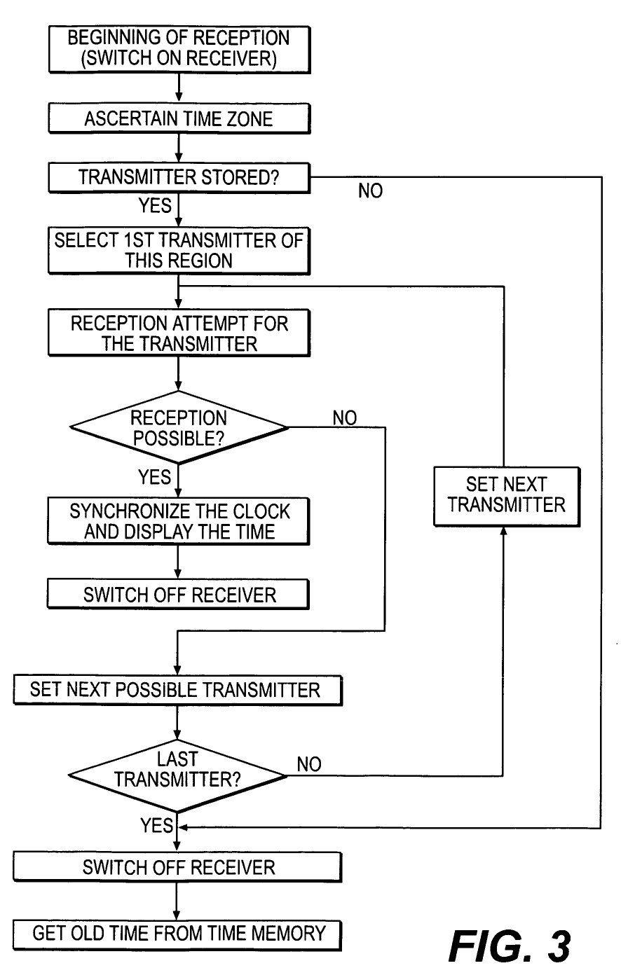

FIG. 3: a flow chart for another exemplary embodiment of a radio-controlled wristwatch, and,

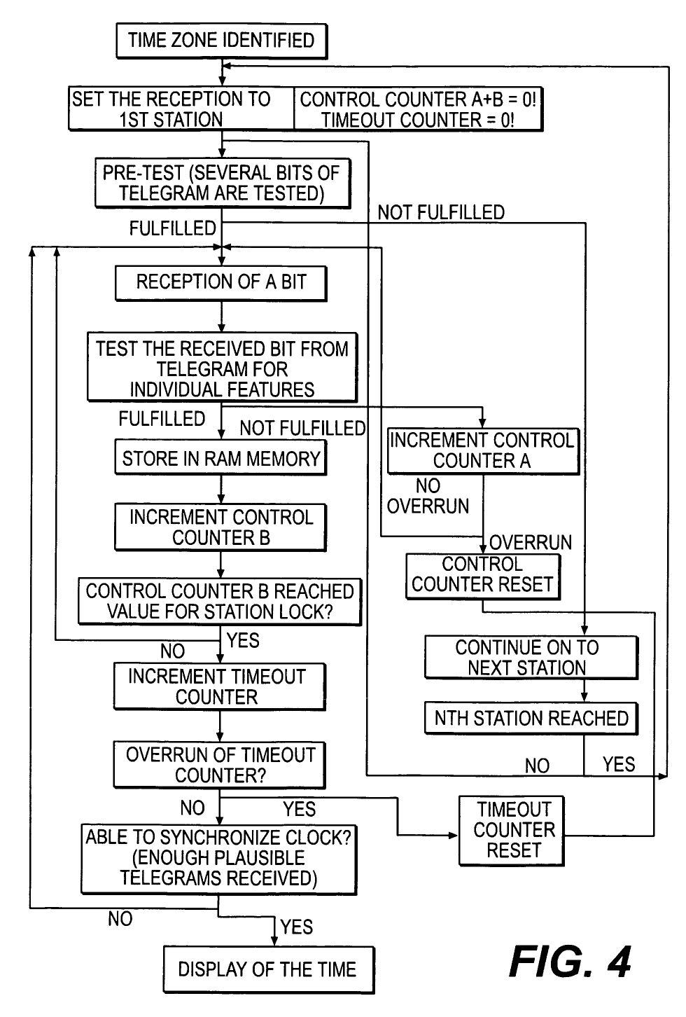

FIG. 4: a detailed flow chart for the exemplary embodiment of FIG. 3.

FIG. 1 shows a schematic block diagram of a radio-controlled wristwatch 20 that has an antenna 22 with a post-connected, switchable receiving device 24 for receiving signals from time signal transmitters 1, 2 . . . 10 from different time zones A, B . . . N. The switchability of receiving device 24 to different carrier frequencies is illustrated symbolically in FIG. 1 by switchable quartz crystals 25. The switching is controlled by a control device 28. The output of receiving device 24 is connected to a decoding device 26, by which the received time signals can be decoded. From the decoded time signal of the received signal, information for a display 32 of radio clock 20 is generated. The display can be in analog form by means of hands, or digital by means of digital display elements. Control device 28 is connected to a memory device 30 in which are stored, among other things, a table with a large amount of information about various time signal transmitters. On the basis of this information stored in the table, control device 28 controls receiving device 25 and decoder 26 in a manner that will be explained later. In addition, radio controlled wristwatch 20 has a switch 34 that is in contact with control device 28. Using this switch 34, an operator can set the time zone in which he is currently located on the radio watch 20. The information about the correct time zone is beneficial, in order to possibly provide more quickly than usual for reception of time signals.

Two additional possible exemplary embodiments of the previously mentioned table of memory device 30 are shown at the bottom of FIG. 1. To the left is a single-column table with M lines that correspond to memory locations. In the M lines a plurality of time signal transmitters are stored one after another, for example in the sequence DCF, MSF, WWVB, JJY40, JJY60, X, Y, Z, V, W, etc.

In the other exemplary embodiment shown to the right thereof the stored table has eight lines and N columns. The individual transmitters are stored in columns, grouped in the time zones A, B to N. In time zone A, which corresponds for example to the European time zone, the time signal transmitters DCF, MSF, XY are stored in order. The other memory locations are still free in the left column for time zone A. In the second column, for time zone B, the time signal transmitters WWVB and Z are stored in order. The other memory locations are free. In the right-most column of the second exemplary embodiment, three time signal transmitters for e.g. the Japanese time zone N are stored in order, namely JJY40, JJY60 and V. The other memory locations are free and can be assigned if necessary, for example if additional time signal transmitters should begin operating.

FIG. 2 illustrates a first possible functional sequence for the operation of the radio controlled wristwatch on the basis of a flow chart. The radio watch here is designed in such a way that it can select from a plurality of time signal transmitters for synchronization. Independently of the selected time zone, the radio watch attempts to receive one of the time signal transmitters stored in the table, on a world-wide basis.

The function begins as follows. The receiver is switched on for example by inserting the battery or by switching on the power supply. If the watch is already running, the reception is activated for example regularly at a certain time, e.g. two o'clock in the morning, in order to set the clock time under radio control or to correct it if necessary. First, the time zone in which the radio watch is set is expediently determined. Next a query is performed to determine whether the time zone is set for example to Japan or a corresponding longitude. If so, control unit 28 queries whether signals from the time signal transmitter JJY40 are being received. If reception is possible, the watch is synchronized and the time on the display is set accordingly. The receiver is then switched off, to be switched on again for example at certain intervals.

If it is determined that reception of the time signal transmitter JJY40 was not possible, an attempt at reception is carried out for the time signal transmitter JJY60. If reception is possible there, the watch is synchronized accordingly and the time is set. If reception of the time signal transmitter JJY60 is also not possible, the aforementioned procedure is repeated until a timeout counter recognizes a specified number of attempts as failed. The receiver is then switched off, and the old time from the time memory, which is provided for example by a quartz time base in the radio watch, is displayed.

If the time zone is not set to Japan or a corresponding longitude, control device (28) queries whether the time zone is set to DCF or a corresponding longitude (see FIG. 2b). If so, a query is made as to whether reception of the time signal transmitter DCF77 is possible. If reception is possible, the watch is synchronized accordingly and the time is set, and the receiver is then switched off. If reception is not possible, the attempt continues to be made through the aforementioned timeout counter to synchronize to the reception of the time signal transmitter DCF (77) until a predetermined time is reached. If reception is ultimately not possible, the receiver is switched off and the old time from the time memory is displayed.

If the query after the time zone has ascertained that the watch is not set either to the Japanese time zone nor to the time zone of DCF, the control device queries whether the time zone is set to WWVB and hence the American time zone. If so, a check is performed to determine whether reception of the time signal transmitter WWVB is occurring. If reception is possible, the watch is synchronized and the corresponding time is displayed. The receiver is then switched off. If reception of the time signal transmitter WWVB is not possible, the timeout counter is incremented again until it is finally determined that reception of the time signal transmitter WWVB is not possible.

In the next step the remaining time signal transmitters are queried in order, and then an analysis is performed as to whether reception of a time signal transmitter is possible.

FIG. 3 shows a different sequential schema of how the radio-controlled wristwatch can work. First it is again determined whether the receiver is switched on. Then the time zone is ascertained. In the next step the question is asked as to whether any time signal transmitters are stored in memory device 30. If not, the receiver is switched off already at this point and the “old time” found in the time memory is displayed.

On the other hand, if time signal transmitters are stored in memory device 30 the first transmitter of this area is selected and an attempt at reception of that transmitter is carried out. If reception is possible, the watch is synchronized with that transmitter and the time is set. The receiver is then switched off. If reception is not possible with the first transmitter, control device 28 selects the next permissible time signal transmitter in memory device 30. An attempt at reception is made for this next transmitter. If reception is possible the watch is synchronized accordingly and the time is set. If reception is not possible, the controller switches to the next transmitter, etc.

If reception of time signals is possible with any of these time signal transmitters addressed by control device 28 via the table in memory device 28, the corresponding time from the time signal transmitter is set on the radio watch. But if reception is also not possible with the last time signal transmitter reviewed, the display of the radio watch is defined by means of the quartz time base, and thus not under radio control.

If no information about the current time is set on the watch, the exemplary embodiment defined in conjunction with FIG. 3 can use the table shown at the lower left of FIG. 1 and query each possible time signal transmitter in order. But if control device 30 of radio watch 20 has received information about the time zone, for example via the switch 34, memory device 28 can see to it that only those time signal transmitters are queried to which switch 34 of radio watch 20 is also switched. This means that in the table of FIG. 1 at the lower right only the time signal transmitters of a single column will be queried.

FIG. 4 shows another more detailed flow chart for FIG. 3, which is self-explanatory.

The efficiency of control device (28) is increased if care is taken during new attempts at reception to ensure that reception is begun with a time signal transmitter with which synchronization of the watch was most recently possible. If reception is then not possible with this transmitter, the procedure continues with the next transmitter from the preceding table. If synchronization was impossible with all of the listed transmitters, the reception block is broken off, and the procedure is re-started at a later time with the next reception block according to the same procedure. But if reception is possible with a new transmitter, the watch is synchronized. The reception attempts are then started with the next reception block with this transmitter.

### REFERENCE LABELS

A . . . N Time zones
M Column
1 . . . 10 Time signal transmitters
20 Radio-controlled wristwatch
22 Antenna
24 Reception device
25 Quartz crystal
26 Decoder
28 Control device
30 Memory device
32 Display
34 Switch

What is claimed is:

1. A radio-controlled wristwatch (20) with means (26) for decoding signals from time signal transmitters (1 . . . 10) from a number of time zones (A . . . N), as well as means for displaying the time on a display (32) of the wristwatch (20) according to a time signal transmitter (1 . . . 10) received in a time zone (A . . . N), characterized in that a table of more than four time signal transmitters (1 . . . 10) from more than two time zones (A . . . N) is stored in a memory unit (30), and that attempts at reception from the transmitters (1 . . . 10) stored in the table are performed automatically by means of a control device (28), and when reception of a time signal transmitter (1 . . . 10) from the table is successful the corresponding time is displayed on the display (32) of the wristwatch.

2. The radio-controlled wristwatch according to claim 1, characterized in that the time signal transmitters (1 . . . 10) stored in the table are grouped by time zones (A . . . N).

3. The radio-controlled wristwatch according to claim 1 or 2, characterized in that attempts at reception are carried out by the control device (28) for all time signal transmitters (1 . . . 10) stored in the table.

4. The radio-controlled wristwatch according to claim 3, characterized in that the attempts at reception take place in sequence for all of the time signal transmitters (1 . . . 10) stored in the table.

5. The radio-controlled wristwatch according to claim 1 or 2, characterized in that the control device (28) only carries out attempts at reception for the time signal transmitters (1 . . . 10) grouped in a time zone in which a time zone setting device (34) of the wristwatch (20) is set.

6. The radio-controlled wristwatch according to one of claims 1 through 5, characterized in that information can be stored in the memory device (30) that indicates the time signal transmitter (1 . . . 10) with which a most recent successful attempt at reception was carried out, and that according to this stored information a new reception attempt is begun by the control device (28) with the reception of this time signal transmitter (1 . . . 10).

7. The radio-controlled wristwatch according to one of claims 1 through 6, characterized in that when attempts at reception are unsuccessful the display shown on the display (32) of the wristwatch (20) is derived from a quartz time base located in the wristwatch (20).

8. The radio-controlled wristwatch according to one of claims 1 through 7, characterized in that the display (32) is an analog watch face.

9. The radio-controlled wristwatch according to one of claims 1 through 7, characterized in that the display (32) is a digital display.
